(19) United States
(12) Patent Application Publication
(10) Pub. No.: US 2015/0288684 A1
(43) Pub. Date: Oct. 8, 2015

(54) DEVICE ASSEMBLY FOR CARRYING OUT OR ENABLING AN ELECTRONIC SERVICE AND A METHOD FOR SECURELY INPUTTING AUTHORIZATION DATA

(71) Applicant: ROSCH HOLDING UND CONSULTING GMBH, Muenchen (DE)

(72) Inventors: Robert Schneider, Salzburg (AT); Istvan Czobel, Quarten (CH)

(21) Appl. No.: 14/420,254

(22) PCT Filed: Aug. 8, 2013
(86) PCT No.: PCT/EP2013/066636

§ 371 Date: Feb. 6, 2015

(30) Foreign Application Priority Data
Aug. 10, 2012 (DE) 10 2012 015 913.7

(51) Int. Cl. H04L 29/06; G06F 3/0488; H04W 12/06

(52) U.S. Cl. CPC H04L 63/0853; H04W 12/06; G06F 3/04886; G06F 3/0488

(57) ABSTRACT

A device assembly for carrying out or enabling an electronic service includes a mobile device on which an operating system runs and which includes a network interface for connection to a network, and a touch-screen display, and a separate electronic module that is connected to the mobile device via an interface and includes a card reader for a chip card as well as a control unit. An application program installed on the mobile device generates an input window on the touch-screen display of the mobile device, via which input window a user can input authorization data for carrying out or enabling the electronic service, wherein the input window includes an arrangement of virtual keys.

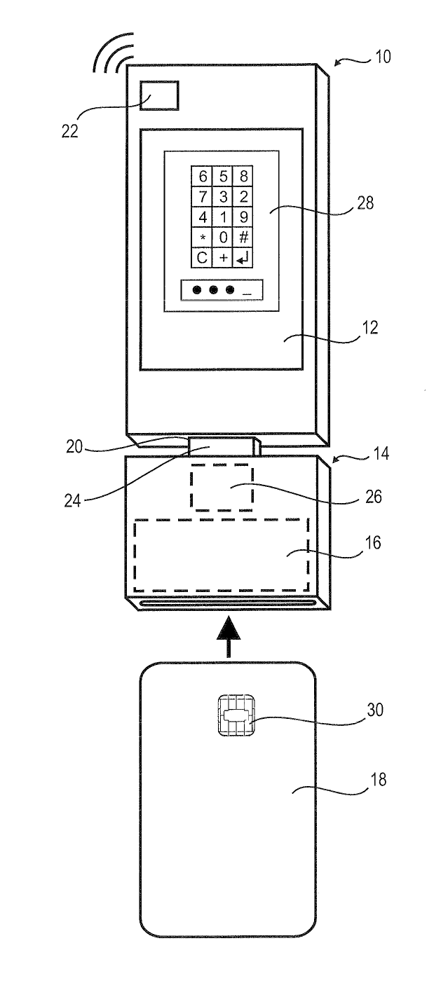

The invention relates to a device assembly for carrying out or enabling an electronic service. The invention also relates to a method for securely inputting authorization data for carrying out or enabling an electronic service.

Usually for carrying out or enabling an electronic service that is person-related and/or involves security-relevant or confidential data, a user has to input a Personal Identification Number (PIN) or the like, in order to authenticate him/herself to the system providing the electronic service. An example are financial transactions such as the withdrawal of cash from an automated teller machine or the carrying out of a cash-free payment process at a POS terminal (Point-of-Sale terminal) using a debit card.

It is the object of the invention to make the process of carrying out or enabling such an electronic service more flexible and cost-effective, whilst however ensuring the required security for the user.

This object is achieved by a device assembly having the features of claim 1 or by a device assembly having the features of claim 2, and by means of a method having the features of claim 8. Advantageous and expedient embodiments of the device assemblies according to the invention and the method according to the invention are set forth in the associated dependent claims.

According to a first aspect of the invention, the device assembly according to the invention for carrying out or enabling an electronic service comprises a mobile device, in particular a smart phone, a Personal Digital Assistant (PDA), a (Sub-) Notebook, a Netbook or a tablet computer, on which an operating system runs and which includes a network interface for connection to a network. Moreover, the device assembly comprises a separate electronic module that is connected to the mobile device via an interface and includes a card reader for a chip card as well as a control unit. According to the invention, the control unit of the electronic module is configured such that it can generate an input window on the mobile device that is independent of the operating system of the mobile phone, via which input window a user can input authorization data for carrying out or enabling the electronic service.

According to a second aspect of the invention, the device assembly according to the invention for carrying out or enabling an electronic service comprises a mobile device on which an operating system runs, and which includes a network interface for connection to a network, and a touch-screen display. Moreover, the device assembly comprises a separate electronic module that is connected to the mobile device via an interface and includes a card reader for a chip card as well as a control unit. According to the invention, an application program is installed on the mobile device, which is configured to generate an input window on the touch-screen display of the mobile device, via which input window a user can input authorization data for carrying out or enabling the electronic service, wherein the input window includes an arrangement of virtual keys. Moreover, the control unit of the electronic module is configured such that it provides individual raster graphics for at least some of the virtual keys, which raster graphics are displayed by the application program in the position of the respective virtual key.

The invention is based on the finding that the functionality that is required for carrying out or enabling an electronic service does not need to be tied to specific application-specific devices, such as for example a stationary POS terminal. According to the invention, a mobile device enhanced by a special electronic module having a chip card reader allows exactly this functionality, in principle without any limitations in terms of location and without any compromises in respect of security or data protection. To this end, the invention contemplates the combination of inputting personal authorization data (PIN or the like) with check data deposited on a chip card of the user, which input of the authorization is particularly secure. The chip card may be a smart card, a SIM card or a similar card having an integrated chip. In any case, the size of the chip card (form factor) is not essential to the invention.

According to the first aspect of the invention, owing to the fact that the input window for inputting authorization data is neither provided by the operating system of the mobile device, which in principle does not provide sufficient security, nor by a program installed on the mobile device, but by the control unit of the electronic module, it is considerably harder to spy out the input data.

According to the second aspect of the invention, in which virtual keys are displayed on the touch-screen display of the mobile device, the layout of which keys cannot be detected by the mobile device anyway but can be determined by the electronic module for each input, it is basically impossible to spy out the authorization data input on the side of the mobile device.

The electronic module of the device according to the invention can be produced in a cost-effective manner, since apart from the card reader and the specific control any further hardware and software components which are necessary for carrying out or enabling the electronic service are provided by the mobile device. In other words, basically any pre-existing mobile device with network connectivity can be upgraded (temporarily) with an electronic module according to the invention to form a POS etc.

In order to eliminate the risk of spying out of critical data as effectively as possible, it is provided that the control unit of the electronic module uses an encryption technology and is configured to immediately encrypt the data read from the chip card and to transmit any security-relevant or confidential data from the electronic module only in an encrypted form. In this way, a secure channel is established between the card reader and the outside world, in particular the mobile device, so that it is ensured that the critical data can be manipulated neither in the mobile device nor during the transmission from the mobile device to a server.

The input of the authorization data by the user can be made even more secure by configuring the control unit or the application program such that upon generation of the input window, a block of numbers or letters with user-selectable virtual keys (number, letter and/or symbol fields) laid out in a randomized way is displayed. After all the possibility cannot be ruled out that any normal key inputs on the mobile device are monitored by special malware programs. However, since by virtue of the input window the input of the authorization data is carried out in a specific way by selecting the displayed virtual keys, the randomized initial position of which can moreover not be predicted, it is basically impossible to spy out such an input.

The input of the authorization data via a touch-screen is advantageous in particular in combination with the randomized layout of the user-selectable virtual keys of the input window, since the selection of the virtual keys using fingers or a stylus is very comfortable and cannot be tracked like in the case of a real keypad with a fixed predetermined key layout.

An advantageous physical connection and a data connection between the electronic module and the mobile device can most conveniently be achieved by connecting the mobile device and the electronic module with each other via a port and a plug-in connector.

According to another preferred embodiment of the invention, the mobile device and the electronic module are connected to each other in a wireless manner, i.e. by radio. The radio connection can be established for example according to the Bluetooth standard or using a comparable technology. The radio connection has the advantage that no physical connection between the mobile device and the electronic module is required. The separation of the mobile device and the electronic module not only during the storage, but also during the operation of the electronic module ensures an even higher level of security, because the dedicated radio connection makes the electronic module less vulnerable to attack, so that it cannot easily be spied out.

Preferably, the electronic module has its own firmware (intelligence) independent of the mobile device, which cannot be manipulated.

The method according to the invention for securely inputting authorization data for carrying out or enabling an electronic service comprises the following steps:
providing a device assembly according to the invention;
connecting the electronic module to the mobile device (e.g. by radio, by way of a plug-in connection or by cable);
inserting a chip card into the card reader;
generating an input window with a layout of virtual keys on the touch-screen display of the mobile device by using an application program installed on the mobile device;
displaying raster graphics in the positions of the virtual keys, which raster graphics are provided by the control unit of the electronic module;
inputting authorization data via the input window by a user touching the virtual keys;
decoding the input authorization data in the control unit; and
verifying the decoded authorization data by using the chip card.

With regard to the advantages of the method, reference is made to the above explanations regarding the device assembly according to the second aspect of the invention.

According to a preferred process flow of the method according to the invention, the control unit provides, upon request of the application program, an individual raster graphic for each virtual key and transmits it to the mobile device in an encrypted form. The application program then displays each key with the raster graphic designated for it according to an association specified by the control unit.

To ensure that the association of the raster graphics with the virtual keys cannot be tracked or reproduced, the association is, for the sake of security, carried out by a random generator, in particular a hardware-based random generator.

As a result of the fact that the application program only stores the order of positions of the touched virtual keys as a code and sends this code to the control unit for decoding, even an interception of the input data would be harmless because the order of positions by itself does not allow an association with the input numbers, letters or symbols. The order of positions can be decoded only by the electronic module, i.e. the actual authorization data will be uncovered only in the protected electronic module.

In order to check the user's input, the control unit, upon decoding the order of positions, verifies the authorization data thus determined by using of the chip card.

A further development of the invention provides for a connection of the electronic module to a remote server via the network interface of the mobile device. As a result, the functionalities of the electronic module can be supported, enhanced or taken over as a whole.

In order to achieve the object, according to an alternative aspect of the invention a device assembly for carrying out or enabling an electronic service is provided, comprising a mobile device on which an operating system runs, and which has a network interface for connecting to a network and a display, and comprising a separate electronic module that is connected to the mobile device via an interface and that includes a card reader for a chip card as well as a control unit. On the mobile device an application program is installed that is configured to generate an input window on the display of the mobile device, via which input window a user can input authorization data for carrying out or enabling the electronic service. The electronic unit has its own keypad and the control unit of the electronic module is configured to allow the authorization data to be input via the keypad of the electronic module.

Further features and advantages of the invention result from the description following below and from the attached drawings, to which reference will be made. In the drawing, the only FIGURE shows a device assembly according to the invention with a chip card.

The FIGURE shows a device assembly for carrying out or enabling an electronic service. The device assembly essentially consists of a mobile device 10 with a display 12, preferably a touch-screen, and a tamper-proof electronic module 14 having a card reader 16 for a chip card 18. The card reader 16 may be a contact or contact-free reader, e.g. suitable for chip cards according to the ISO 7816 standard or the ISO/IEC 14443 standard.

An operating system, which allows the use of the mobile device in a known manner, runs on the mobile device, which may be a smart phone, a Personal Digital Assistant (PDA), a (Sub-)Notebook, a Netbook, a tablet computer or the like. Further, a special application program (App) for carrying out one or more electronic services is installed on the mobile device 10, which will be explained in more detail below.

The mobile device 10 has at least one port 20 for plugging in a connection cable or a periphery device (e.g. a USB port or a dock connection). Moreover, the mobile device 10 has a network interface 22 for connecting the mobile device 10 to the digital telephone network or another network, in particular a local network and/or the internet.

Apart from the card reader 16, the electronic module 14 includes a plug-in connector 24 matching the port 20 of the mobile device 10, which plug-in connector 24 allows a physical connection and a data transfer between the electronic module 14 and the mobile device 10. Moreover, the electronic module 14 can be supplied with power through the mobile device 10 via this interface.

However, the connection between the mobile device 10 and the electronic module 14 may also be wireless. To this end, a radio connection according to the Bluetooth standard or a similar technology may be provided. In this case, the electronic module 14 cannot only be stored but also be used physically separated from the mobile device 10.

The functionality of the electronic module 14, including its card reader 16, is provided by a control unit 26 in the form of one or more integrated circuits (ASIC, microprocessor or microcontroller). In particular, the control unit 26 uses a powerful encryption technology. Any data stored on the chip 30 of a chip card 18 will be encrypted even prior to being read. Also, any security-relevant or confidential data is sent from the electronic module 14 only in an encrypted form, so that any possibility of manipulation of this data in the mobile device 10 or outside of it is eliminated.

The control unit 26 of the electronic module 14 is therefore capable of establishing an encrypted channel for secure data transmission between the electronic module 14 and the mobile device 10 via the plug-in connector 24 and the port 20. By using this secure channel, the control unit 26 can generate an input window 28 on the display 12 of the mobile device 10 independently of the operating system of the mobile device 10. The input window 28 is visible only to the user of the mobile device 10, however not to the operating system of the mobile device 10. The basic technology for the way an input window 28 can be generated on the mobile device 10 independently of its operating system is apparent for example, from the document “Intel® Identity Protection Technology with PKI” (available on the Internet under: http://ipt.intel.com/Libraries/Documents/Technology_Overview_-_Intel%C2%AE_I dentity_Protection_Technology_with_PKI.pdf).

The mode of operation of the device assembly will be described below by way of example for a case in which the device assembly replaces a conventional cable-bound and thus stationary, POS terminal.

For making a cashless payment, the electronic module 14 is connected to the mobile device 10 and the application program is launched. The desired payment amount is input into the mobile device 10 via an input window that is provided by the application program. Subsequently, the customer (user) is prompted to insert the chip card 18 into the card reader 16. These steps are usually, but not necessarily, carried out by the payment recipient.

Plausibility and validity of the chip card 18 are checked via the online connection of the mobile device 10, which was established through the network interface 22 thereof, in particular in respect of whether the chip card 18 is approved and has not expired yet. Upon passing the check successfully, the control unit 26 of the electronic module 14 generates the input window 28 on the display 12 of the mobile device 10 and prompts the customer to input his/her PIN valid in connection with the chip card 18.

Subsequently, the customer enters the PIN via the touch-screen display 12 on the mobile device 10. Neither the input window 28 nor the inputting of the PIN can be detected by the operating system of the mobile device 10. The PIN is immediately forwarded to the chip 30 of the chip card 18 via the secure channel. The correctness of the PIN is checked in the chip 30; no checking or processing of the PIN is carried out in the mobile device 10. If the result is positive, the cashless payment process is carried out in a known manner via the online connection with the customer's bank, with the relevant data being transferred in an encrypted form.

In order to enhance security, a block of numbers or letters with user-selectable number, letter and/or symbol fields is displayed on the display 12 of the mobile device 10 upon generation of the input window 28, and the order of these fields, which will be referred to below as virtual keys, i.e. their arrangement relative to each other, is randomized. Thus, the layout of the virtual keys in the input window 28 is random for each input, which makes spying out the PIN input considerably more difficult. The randomization of the input window 28 is controlled solely by the control unit 26 of the electronic module 14, if necessary in combination with the chip 30 of the chip card 18 or of data stored thereon.

Another preferred variant of the method for securely inputting authorization data for carrying out or enabling an electronic service will now be described. The method is again based on the device assembly with the mobile device 10 as described above, which includes a touch-screen display 12, and the separate tamper-proof electronic module 14 that has a contact or contactless card reader 16 for a chip card 18. The electronic module 14 that can be connected to the mobile device 10 has its own firmware that is independent of the mobile device 10.

The variant described here differs in the input of the PIN, which should remain invisible to the respective operating system of the mobile device 10. The specific application program (App) installed on the mobile device 10 for carrying out or enabling the electronic service generates an input window 28 with an initially “empty” block of numbers or letters in the display 12 of the mobile device 10. The control unit 26, more specifically the firmware of the electronic module 14, generates, upon request of the application program, an individual raster graphic (bitmap) for each virtual key of the block of numbers or letters and transmits this raster graphic to the mobile device 10 in an encrypted form. The application program displays, according to an association specified by the control unit 26, each key with the raster graphic designated for it. The raster graphics themselves represent numbers, letters or symbols that are visible only to the human eye, e.g. on the basis of a seven-segment display. This means that neither the operating system of the mobile device 10 nor the application program or any spyware or the like can associate such a raster graphic to the character represented thereby.

The layout of the raster graphics in the input window 28 is determined at random. Each time the program initiates a PIN input, the control unit 26 activates a random generator in the electronic module 14, which is preferably hardware-based. The result of the random generator determines the layout of the raster graphics and thus the layout of the numbers, letters or symbols represented by raster graphics, which can be selected for input.

The customer (user) inputs his/her PIN by touching the corresponding virtual keys in the input window 28. The application program only stores the order of the positions of the touched virtual keys (sequence of position) and sends this information as a code to the control unit 26 of the electronic module 14.

The control unit 26 can associate the numbers, letters or symbols, as seen by the user whilst touching them, to the order of positions and can in this way determine the PIN the user wants to input. The PIN decoded in this way is verified by using the chip 30 of the chip card 18, as the control unit 26 emits, for example, a PIN comparison command that is per se known.

In a further development of the described input variants, the network interface 22 of the mobile device 10 is used for a connection of the electronic module 14 to a remote server. This connection allows essential functionalities of the control unit 26 of the electronic module 14 and/or additional functionalities to be moved out to the server (as an option). As a result, more powerful encryption and randomization technologies etc. can be made available.

The device assembly provided for carrying out or enabling the electronic service is not tied to a particular location, which is contrary to a conventional POS terminal, but can be used at any location where the mobile device 10 can establish a network connection.

The application example of a financial transaction as described above is by no means to be understood in a limiting sense. In particular, the input of authorization data (PIN or the like) via the randomized input window 28 can be used in many applications, in which security and/or confidentiality of data is important, such as for example in the verification of individuals, e.g. in connection with an electronic passport or with an electronic health card.

A modification of the device assembly described above for carrying out or enabling an electronic service makes use of a separate electronic module 14, which includes its own keypad, but unlike a conventional POS terminal does not have an own display. From a technical point of view, the keypad may be designed in any desired way. The number of keys may be limited to those that are necessary for inputting the authorization data. Otherwise, the design of the device assembly is not substantially modified.

For inputting the authorization data (PIN or the like), the particular application program installed on the mobile device 10 likewise generates an input window 28 with an input field on the display 12 of the mobile device 10. However, the user does not input the authorization data via the mobile device 10, but via the keypad of the electronic module 14. The control unit 26 of the electronic module 14 is configured accordingly, so that the authorization data is transmitted from the electronic module 14 to the mobile device 10 (in an encrypted form). Upon each key actuation, only a place holder (“*”, “•” or the like) appears in the input field on the display 12 of the mobile device 10.

This makes it even more difficult to spy out the input of the user, because it is not the keypad or the touch display 12 of the mobile device 10 that is used, but the separate keypad that is distinct from the mobile device 10. The connection between the mobile device 10 and the electronic module 14 is preferably a (not permanent) radio connection, but in principle also the other types of connection as mentioned above may be used.

A further application possibility, in which each of the variants of the device assembly as described above is used for carrying out or enabling an electronic service, will be described below.

In order to link a user with a user account of a network-based service (cloud service), the user usually has to log in at the beginning of a session by inputting a user name and a password or similar access data (login credentials). This data allows the user to be authenticated on the side of the service. In order to simplify this cumbersome procedure, the input of the access data is replaced with the input of a PIN or the like by means of the electronic module 14. To this end, any one of the PIN input methods described above may be used.

The modified log-in, where the user has to memorize only his/her personal PIN, but not a user name or a (complex, secure) password, requires, on the side of the mobile device 10, a correspondingly modified application program (App) for calling up the service, so that instead of calling up the usual access data, the secure PIN input is initiated. Moreover, the application program and the service are to be matched to each other in such a way that as a result of the transmission of the PIN, an authentication in connection with an exchange of keys between the service and the application is carried out. These keys then allow a secure communication between the mobile device 10 and the service.

As a result of the modified log-in with a secure PIN input it becomes considerably more difficult to “crack” a user account.

Whilst the main applications of the invention are based on a combination of the electronic module 14 with the mobile device 10, it is of course also possible to combine the electronic module 14 with a stationary device, in particular a desktop PC (with a touch-screen).

### LIST OF REFERENCE NUMERALS

10 Mobile device
12 Display
14 Electronic module
16 Card reader
18 Chip card
20 Port
22 Network interface
24 Plug-in connector
26 Control unit
28 Input window
30 Chip

1. A device assembly for carrying out or enabling an electronic service, comprising:
a mobile device on which an operating system runs and which includes a network interface for connection to a network, and
a separate electronic module that is connected to the mobile device via an interface and includes a card reader for a chip card as well as a control unit,
wherein the control unit of the electronic module is configured such that it can generate an input window on the mobile device independent of the operating system of the mobile device, via which input window a user can input authorization data for carrying out or enabling the electronic service.

2. The device assembly for carrying out or enabling an electronic service, comprising:
a mobile device on which an operating system runs, and which has a network interface for connection to a network, and a touch-screen display, and
a separate electronic module that is connected to the mobile device via an interface and includes a card reader for a chip card as well as a control unit.
wherein an application program is installed on the mobile device, which is configured to generate an input window on the touch-screen display of the mobile device, via which input window a user can input authorization data for carrying out or enabling the electronic service, wherein the input window includes an arrangement of virtual keys, and
in that the control unit of the electronic module is configured to provide individual raster graphics for at least some of the virtual keys, which raster graphics are displayed by the application program in the position of the respective virtual key.

3. The device assembly according to claim 1, wherein the control unit uses an encryption technology and is configured to immediately encrypt data read from the chip card and to transmit security-relevant or confidential data from the electronic module only in an encrypted form.

4. The device assembly according to claim 1, wherein the control unit or the application program is configured such that a block of numbers or letters with user-selectable virtual keys is displayed upon generation of the input window, which virtual keys are laid out in a randomized way.

5. The device assembly according to claim 1, wherein the mobile device and the electronic module are connected to each other via a port and a plug-in connector.

6. The device assembly according to claim 1, wherein the mobile device and the electronic module are connected to each other in a wireless manner.

7. The device assembly according to claim 1, wherein the electronic module has its own firmware that is independent of the mobile device.

8. A method for securely inputting authorization data for carrying out or enabling an electronic service, comprising the following steps:
providing a device assembly according to claim 2;
connecting the electronic module to the mobile device;
inserting a chip card into the card reader;
generating an input window with a layout of virtual keys on the touch-screen display of the mobile device by using an application program installed on the mobile device;
displaying raster graphics in the positions of at least some of the virtual keys, which raster graphics are provided by the control unit of the electronic module;
inputting authorization data via the input window by a user touching the virtual keys;
decoding the input authorization data in the control unit; and
verifying the decoded authorization data by using the chip card.

9. The method according to claim 8, wherein the control unit provides, upon request of the application program, an individual raster graphic for each virtual key and transmits it to the mobile device in an encrypted form, and in that the application program displays each key with the raster graphic designated for it according to an association specified by the control unit.

10. The method according to claim 9, wherein the association of the raster graphics with the virtual keys is carried out by a random generator.

11. The method according to claim 8, wherein the application program stores the order of positions of the touched virtual keys as a code and sends this code for decoding to the control unit.

12. The method according to claim 11, wherein the control unit verifies, after decoding the order of positions, the authorization data determined in this way by using the chip card.

13. The method according to claim 8, wherein the network interface of the mobile device is used for connecting the electronic module to a remote server.

14. A device assembly for carrying out or enabling an electronic service, comprising:
a mobile device on which an operating system runs, and which includes a network interface for connection to a network, and a display, and
a separate electronic module that is connected to the mobile device via an interface and includes a card reader for a chip card as well as a control unit, wherein
an application program is installed on the mobile device, which is configured to generate an input window on the touch-screen display of the mobile device, via which input window a user can input authorization data for carrying out or enabling the electronic service, and
in that the electronic module includes its own keypad without a display, the control unit of the electronic module being configured to allow the authorization data to be input via the keypad of the electronic module.

15. The device assembly according to claim 2, wherein the control unit uses an encryption technology and is configured to immediately encrypt data read from the chip card and to transmit security-relevant or confidential data from the electronic module only in an encrypted form.

16. The device assembly according to claim 2, wherein the control unit or the application program is configured such that a block of numbers or letters with user-selectable virtual keys is displayed upon generation of the input window, which virtual keys are laid out in a randomized way.

17. The device assembly according to claim 2, wherein the mobile device and the electronic module are connected to each other via a port and a plug-in connector.

18. The device assembly according to claim 2, wherein the mobile device and the electronic module are connected to each other in a wireless manner.

19. The device assembly according to claim 2, wherein the electronic module has its own firmware that is independent of the mobile device.
